(19) United States
(12) Patent Application Publication
(10) Pub. No.: US 2013/0092730 A1
(43) Pub. Date: Apr. 18, 2013

(54) INTERACTIVE CODE PROCESSING PLATFORM PROVIDING INTERACTION BETWEEN PARTIES GENERATING AND DISSEMINATING SINGLE AND MULTIDIMENSIONAL OPTICAL AND DIGITAL CODES

(71) Applicant: JACQUES BLINBAUM, NEW YORK, NY (US)

(72) Inventor: JACQUES BLINBAUM, NEW YORK, NY (US)

(21) Appl. No.: 13/632,569

(22) Filed: Oct. 1, 2012

Related U.S. Application Data
(60) Provisional application No. 61/543,646, filed on Oct. 5, 2011.

(51) Int. Cl. G06K 19/06; G06F 17/00

(52) U.S. Cl. CPC G06K 19/06009; G06F 17/00; G06K 19/06037
USPC 235/375; 235/494

(57) ABSTRACT

An optical or digital code processing solution that identifies users and generates customized or programmable response actions based upon variables, profiles, histories, business models, and other criteria. An interactive solution that adds value to existing multi-dimensional optical and digital codes by creating targeted and customized responses. An interactive solution that enables a code capture to commence a chain of programmed responses involving single or multiple users. A code solution that integrates code readers and code generators onto a platform that can be dynamically programmed and updated to generate user specific and input specific responses. A solution that captures user information for tracking, marketing, and data base creation. A solution that integrates codes and responses with payment and financial processing functions.

### CROSS REFERENCE TO RELATED APPLICATIONS

This application claims the benefit of Provisional Patent Application No. 61/543,646 filed on Oct. 5, 2011 by the present inventor.

### BACKGROUND AND PRIOR ART OF THE INVENTION

1. Field of Invention

This invention relates to a process whereby one is able to generate a customized programmable digital or optical code with interactive qualities that allow the code generator to capture the identity and other information from the party reading the code and thereby establish a multi-directional communication link with a customized response.

2. Discussion of Prior Art

Optical codes have been in use for decades as a way to identify products. Basic barcodes have the capacity to hold fixed information that can be read using various code readers. The information stored within these codes is fixed, limited in capacity, and the reading of the code results in a static response. The information imparted within the code cannot be altered once the code has been produced. As an example, the traditional product barcodes printed on products sold in stores has severe limitations. It can contain a limited amount of information, typically a limited string of numbers that are linked to a product data base. Using a barcode scanner the user captures the limited static information and electronically communicates with a data base to lookup the identity of the item. The server responds with a product description and associated information. As an example, a food item is scanned at supermarket checkout and the cash register is provided with a product description and a price based on programming within the server.

Two dimensional codes have a much wider range of applications. They can hold significantly more static information than the traditional barcode. Two dimensional codes can be directed to open Internet web pages on linked web browsers.

In all these cases, codes are read using a reader and the information is used to access information in the form of text, images, or by being directed to a website. The result is that the party generating the code is providing a one-way information response to the reader of the code. Until recently, codes were read by specific code readers installed for that single purpose. Until recently, mobile phones were used to make phone calls and send/receive text messages. Today we are experiencing a rapid growth in the number of smart phones, or SmartPhones, capable of hosting a wide range of functions and capable of integrating mobile applications specifically designed to be integrated into their processing capability. Among those applications are smart phone applications designed to read the various optical codes and, where appropriate, open the integrated web browser to a particular webpage or URL.

### SUMMARY OF THE INVENTION

The present invention is a business process whereby a platform integrates the optical/digital code generator with the code reader in such a way that the generator and the reader are able to identify one another, exchange information, and establish a multi-directional communication linkup.

### Objects and Advantages

The process significantly expands the functionality and value of traditional optical codes. Traditionally the party creating the code was only able to impart information to the party reading the code. In essence it is a one-way transfer of information. The party creating the code has no information as to who is reading the code, where it is being read, when it is being read, what follow up is taking place, what other information the reader is viewing, and how to communicate back to the “reader”.

Using the invention the party creating the code is able to capture information from the party reading the code including, but not limited to:
Mobile phone number
E-mail address
Location where the code was scanned
Time when the code was scanned
Relevant other codes scanned by the reader
A full range of personal information on the party reading the code

Using the information captured the generator is able to communicate with the reader in commercial and non-commercial manner to add significant value to the code application. The present invention can be configured using a wide range of code generation and capture devices including:
Computer based optical readers
Mobile phone based optical readers
Freestanding optical readers
Installed optical readers

The present invention can be configured to use codes including, but not limited to, those displayed as:
Print media
Outdoor advertising
TV, film, projection presentation media
Mobile phone display screens
Apparel, jewelry, personal items
Product identification tags
Coupon programs
Gaming identifiers
Loyalty program identifiers
Political campaign lead generators
Charitable contribution pledge collectors
Attendance capture
Vote capture

The present invention can be integrated with user defined tables/matrixes that customize the results to respond to the particulars of the various parties
Geographic location
Personal data
Prior transaction history
Pricing models
Privacy settings

This solution operates in either a mobile, internet, or physical reader environment and all functions are integrated into a single product. Accordingly, several of the objects and advantages of my invention are:
To provide advertisers using optical codes with the ability to gather information on readers/viewers that show interest in their advertising and target responses to those who capture their codes
   Print media
   Outdoor advertising
   TV
   Film
To allow venues and events to use optical codes in order to capture information on attendees and track their preferences so that a follow up relationship can be created. Examples include:
   Trade shows
   Shareholder and corporate meetings
   Exhibitions
   Travel and tourist destinations
   Restaurants
To allow organizations to create optical code based relationships with individuals based on shared interests to create an ongoing communications link.
   Charitable campaigns
   Political campaigns
   Buying groups
   Social action groups
   Social networks
   Teams and clubs
To allow for the creation of loyalty and rewards programs aimed at recognizing customer business
   Retail
   Travel
   Dining
To provide a way to build new customer relationships and expand upon existing relationships
   Coupon marketing programs
   In store giveaways and discounts
   Cross marketing strategies
   Travel and tourism
   Retail
   Hospitality
   Restaurant
To provide for the creation of optical code products directed to social interaction in an interactive environment
   Apparel
   Business cards
   Identifiers on social network websites
To link all of the above to an integrated payment solution facilitating purchases in a closed payment environment
To link all of the above to facilitate payments linked to established payment/credit/debit solutions
To link all of the above to allow for financial transaction using private currencies
   Loyalty points
   Gaming points
   Special purchasing wallet
   Micropayments
   Traditional purchases/payments

### DRAWINGS

FIG. 1 is a flow diagram describing how the process is developed. The process involves the integration of three separate modules labeled as “Customer Code Reader”, “Rules Engine”, and “Merchant Database and Administration”.

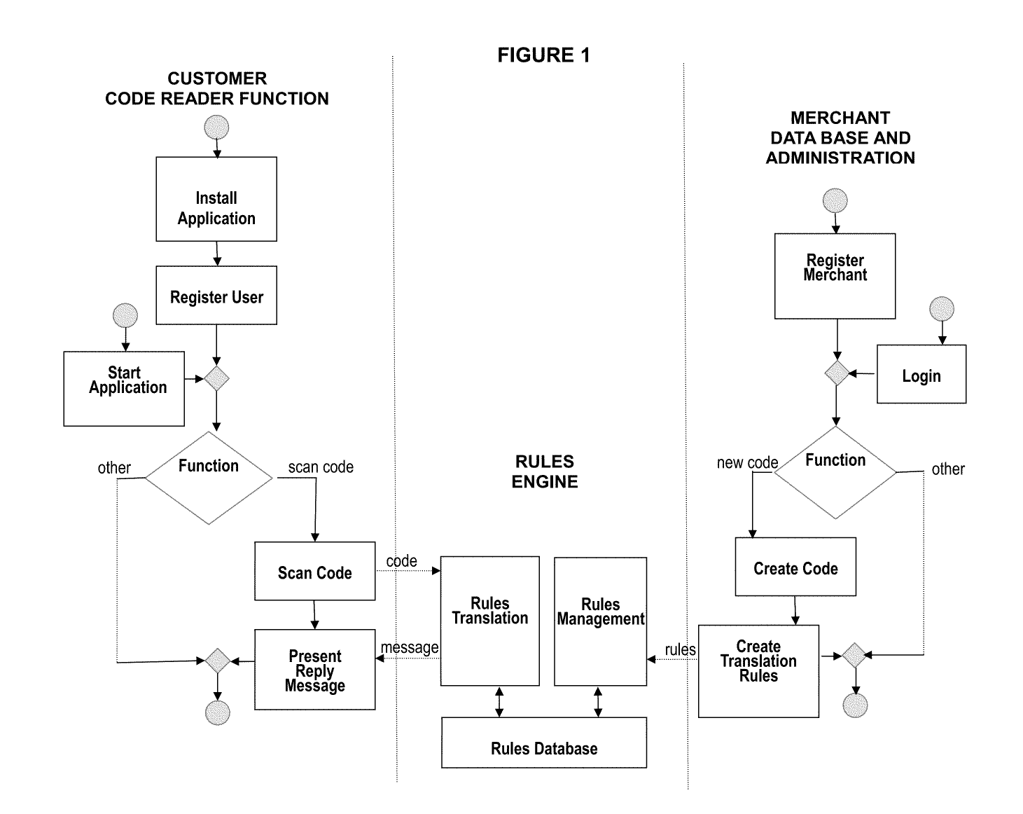

### MERCHANT DATA BASE AND ADMINISTRATION

The Data Base Administration module is based upon the creation of computer software that generates optical Codes with specific parameters embedded therein. The embedded information includes a unique identifier that identifies the Code as being integrated into the proprietary platform and has a specific URL attached to the embedded information. In addition to the embedded information, standard Code functions are included that identify an intended response such as a message, an image, or the opening of a web browser and an associated URL. The primary functions of this module are as follows:
To permit the Merchant to Register on the Platform and to accommodate related functions such as:
   Registration of personal information
   Login
   Account Administration
   Security function
To permit Merchants to create and edit codes which are configured with unique identifiers that include:
   Unique User ID
   Unique Code ID
   Unique sets of response parameters
To permit Merchants to create and edit codes which are used to:
   Provide text responses
   Provide static image responses including coupons
   Provide web based responses
   Open web pages
   Open video responses
   Generate audio responses
   Allow for combinations of all the above
To provide tools and reports that allow for customization and add value to the platform
   Translation Rules to define the matrix of responses generated by a specific Code after consideration of the input variables
   History and analytics functions to track code use
   Report functions to track use of the platform and related codes

### Customer Code Reader Function

The Code Reader Function module is built upon the creation of software that integrates a code reader function with a server function. In many cases this will be accomplished in a SmartPhone environment via an app whereby the SmartPhone camera integrates with its web browser to communicate with a server via the Internet. However, this can also be accommodated in alternative ways including the linking of an independent code scanner to a computer which can communicate to a server either via the Internet or directly as in a closed application.

The Code Reader module is designed to capture customer specific information in multiple ways and to transmit this information to a server data base which is capable of storing and analyzing data. Once the data is processed the server generates a customized response based on a series of predetermined Transaction Rules.

The main functions of the Code Reader are:
To allow Customers to install the program directly onto their SmartPhone via an appropriate app or, on a private network, directly onto their server
   Installation on a SmartPhone allows the platform server to acquire user specific information
      Phone settings and preferences including:
         Phone network settings
         Time and date preferences
         Language preferences
         Wi-Fi settings
      Phone control function capabilities
      Other information related to both integrated phone features and installed phone features including:
         Geo-location capabilities
         Time settings
         Browser settings and options
         Control functions
To allow Customers to Register the Reader into the Platform in order to use the functions
   Installation on a SmartPhone allows the platform server to acquire customer specific information
      Personal information
      Personal preferences
      Contact information
         Phone
         SMS Text Messaging
         Email
To capture the Codes via the camera and browser functions of their SmartPhone
To transmit the information to the server
To receive a response from the server which is determined based on the Transaction Rules.

### Rules Engine

The Rules Engine is comprised of a server which contains programming that consolidates and processes merchant specific sub-programs in such a way as to analyze incoming customer scans, translate the incoming scan request into a format that can be analyzed based upon merchant Rules stored in the Rules Database, and create a customized reply message which is sent back to the customer's Code Reader or SmartPhone.

### DESCRIPTION OF THE PREFERRED EMBODIMENTS

My invention provides for the creation of a platform that can be used by a) entities desiring to reach out to others in order to create a relationship, hereinafter referred to as “Organizers” or “Merchants”, or b) entities desiring to respond to these outreaches, hereinafter referred to as “Members” or “Customers”. In using my invention the parties are able to accomplish their goals using optical codes to establish multi-directional relationships in a mobile and internet based environment.

Using my invention a Merchant creates a Merchant Account via the internet or mobile application. In the creation of the Merchant Account the Merchant provides identity and financial information suitable to satisfy the appropriate requirements of the Platform. Once the Merchant Account is created the Merchant is able to create one or multiple platform specific digital/optical codes (hereinafter referred to as the “Code”). Each of these codes is fixed in its configuration and can be reproduced as a digital image or printed using traditional printing solutions. Each code is identified and stored on the Platform. The Merchant then uses the code as a method of publicizing the Merchant's specific program.

Once the code is created and stored the Merchant is able to access the code on the Platform and ascribe a specific “Action” to the code. This action can be the identification of a web link, the opening of a web file (page, image, video, sound), the creation of a fixed text message, or any combination of the above.

Once the code is created and stored the Merchant can, via the platform, change the Action so that the results communicated upon reading the code can be altered or customized. In addition, using the Platform the Merchant is able to create a Table/Matrix wherein the Merchant can customize the response Action based on the specific Merchant considerations. This may take into consideration the Customer's data including, but not limited to, geographic location, personal profile, or prior transaction history. An example would be a dress advertised in a national magazine including the Platform Code. Once scanned, the response would provide different pricing and sourcing information if the code is captured in New York City as compared to the code being captured in Little Rock, Arkansas. As an alternative this customization may include the Merchant's data like inventory, timing, pricing. An example would be an Action that would give a larger benefit during a slow time of day and a lesser benefit during a busy time of day.

Using my invention a Customer creates a Customer Account via the internet or mobile application. In the creation of the Customer Account the Customer provides identity and other information suitable to satisfy the appropriate requirements of the Platform.

When the Customer sees a Merchant Code the Customer uses the platform code reader application to capture the code. The code is then read, the identity and other information about the Customer are obtained directly from the capture device, and the bundle of information is transmitted to the Platform for processing. Once the processing is completed the Customer receives a return response as determined by the Action. This response can be a message, link, video, sound file, or combination of these. An example of this function might be that a national ice cream chain displays a code promotion in its store in Omaha, Nebraska. The Customer sees the promotional code and uses his smart phone application to capture the code. The application sends a message to the platform including a) the code identifier, b) the customer's identifier, c) the date and time, and d) the geographic location of the transaction. The platform will collect the information, determine that it is associated with the ice cream chain, that the transaction is taking place in Omaha, that the promotion for Omaha in the middle of winter in the morning consists of a free additional scoop of ice cream. The return message will show a coupon entitling the customer to the free scoop of ice cream and the Platform will recognize that the Customer has visited that store five times in the past month.

### DESCRIPTION OF ADDITIONAL EMBODIMENTS

Another use of this invention relates to the electronic payment field. Using this platform a Merchant can place a Code on a product in a physical or digital environment. A Customer would see the Code and using the application capture the code and thereby complete the purchase of the coded item in a seamless transaction. In order to achieve this, the Customer would expand his/her profile with payment and other information that would be processed in a secure environment using traditional security protocols.

The above solution would operate equally efficiently in a) physical store locations, b) using printed Codes in print media, c) via display of codes in TV, film, or other visual media, and d) in group assembly situations via large scale displays of the Code.

Another use of this invention relates to the field of electronic shopping carts. Using the application a Merchant would identify various products using the Codes and the Customer would simply shop the various offerings and capture the codes related to items that he/she desires to purchase. At the end of the shopping trip the platform would process the selections and either a) directly charge the customer for the items selected or b) transmit a summary of the purchases for direct processing by the Merchant.

Again, the above solution would operate equally efficiently in a) physical store locations, b) using printed Codes in print media, c) via display of codes in TV, film, or other visual media, and d) in group assembly situations via large scale displays of the Code.

Another use of this invention relates to TV and other video advertising. A Merchant can display an optical code as part of the transmission in order to generate an Action which can be a purchase, a vote, a contribution, or a request for further information. By capturing the code the viewer would initiate the programmed response seamlessly.

Another use of this invention is to construct a response Action that is linked to a physical undertaking and results in a physical activity. Examples include, but are not limited to:
Robotic Actions where the scan initiates a sequence of robotic commands
Industrial production commands
Shipping and logistics applications
Health care and treatment applications
Dispensing of products
   Food
      Human
      Animal
   Pharmaceuticals

### ADVANTAGES

From the above descriptions a number of advantages of my code system become evident:
My invention is uniquely capable of creating an interactive use of traditional optical code products
My invention is uniquely capable of using smart phone applications to achieve this interactive feature
My invention is uniquely capable of capturing optical codes and presenting a customized response specific to the Customer's personal profile
My invention is uniquely capable of capturing an optical code and presenting a customized response specific to the Customer's location
My invention is uniquely capable of capturing an optical code and presenting a customized response specific to the time and date captured
My invention is uniquely capable of capturing an optical code and presenting a customized response specific to the Customer's past purchasing history/profile
My invention is uniquely capable of capturing the above using all the forms of media identified in this application
My invention is uniquely capable of acting as an electronic wallet using optical codes
My invention is uniquely capable of adding value to TV advertising by creating a seamless real time purchasing option
My invention is uniquely capable of adding value to TV advertising by creating a seamless ability to elect to receive additional information
My invention is uniquely capable of identifying Codes and responding based on cross marketing strategies

### CONCLUSION, RAMIFICATIONS, AND SCOPE

As one can see, my new code system provides a multifaceted and comprehensive solution to the challenge of transacting in optical code environment.
My invention adds significant value to traditional solutions
My invention operates without the need for customized hardware or readers
My invention can be easily integrated with traditional payment systems for purchases
My invention can easily be used in underdeveloped markets
My invention can operate in a more secure manner than traditional physical card payment models

The reader will see that, according to the main embodiment of the invention, I have a provided a new way of expanding the process and the function of optical and digital codes. I have also significantly increased their commercial value by proving a platform that integrates codes and readers in an environment that captures additional predefined and dynamic data and generates a customized response.

While the above description contains many specifics, these should not be construed as limitations on the scope of any embodiments, but as exemplifications of various embodiments thereof. Many other ramifications and variations are possible within the teachings of the various embodiments. Also, the use of terms like Customer, Merchant, Organizer, and Merchant should not be construed as limiting the use of my invention to a sales, or merchant environment. In fact the exact opposite is true since my invention can be used in any environment wherein value is created by integrating a code reader and processor to provide programmable responses.

Thus the scope should be determined by the appended claims and their legal equivalents, and not by examples given.

I claim:

1. A method whereby one is able to create optical codes which can be read by code readers and can generate dynamic customized results based on defined parameters.

2. The method of claim 1 wherein unique sets code identifiers are inserted into the code

3. The method of claim 2 wherein a dynamic barcode is generated and processed

4. The method of claim 2 wherein a dynamic QR Code is created

5. The method of claim 2 wherein a dynamic Tag Code is created

6. The method of claim 2 wherein a dynamic two dimensional optical code is created

7. The method of claim 2 wherein a dynamic three dimensional optical code is created

8. The method of claim 2 wherein a dynamic hologram code is created

9. The method of claim 2 wherein a dynamic digital image code is created

10. The method of claim 2 wherein a dynamic alphanumeric font image is created

11. The method of claim 1 where a code reader is able to gather information and data, capture the code image, and then transmits the bundle of combined information to a processer for analysis and further action.

12. A method whereby one is able to create customized optical code responses which are generated based on user profile information

13. The method of claim 12 using profile information acquired by response from the user during registration and installation of the reader

14. The method of claim 12 using profile information acquired by tracking prior usage of the reader app

15. The method of claim 12 using profile information acquired from the reader's internal settings including:
SmartPhone phone settings
Language
Time
Location
Web Browser ID
Phone Number

16. The method of claim 12 using profile information acquired from the user's browsing and search histories to identify relevant useful profile data
On independent computers used by the reader app user
On other devices identified as linked to the user
On other apps installed on the user's SmartPhone

17. The method of claim 12 using profile information acquired by identifying the user and others linked to the user through online and offline social networks to produce customized code responses
